(19) United States
(12) Patent Application Publication
(10) Pub. No.: US 2005/0000913 A1
(43) Pub. Date: Jan. 6, 2005

(54) Fluid treatment system

(76) Inventor: Mark Betterly, Fort Washington, PA (US)

Correspondence Address: RATNERPRESTIA, P O BOX 980, VALLEY FORGE, PA, 19482-0980, US

(21) Appl. No.: 10/613,452

(22) Filed: Jul. 3, 2003

(51) Int. Cl. C02F 1/32

(52) U.S. Cl. 210/748

(57) ABSTRACT

A system for exposing a fluid to UV energy for treatment of the fluid is provided. The system includes a fluid passageway at least partially defined by a UV energy transmissive barrier. The system also includes at least one UV energy source positioned to transmit UV energy through the UV energy transmissive barrier and into the fluid passageway. Additionally, at least one UV energy sensor is positioned to sense UV energy transmitted through the UV energy transmissive barrier. The at least one sensor is configured to detect a reduced amount of UV energy transmitted through the UV energy transmissive barrier.

### FIELD OF THE INVENTION

This invention relates to a system for treating fluids, and more particularly, to a system for treating fluids using UV energy.

### BACKGROUND OF THE INVENTION

Disinfection of fluids (e.g., potable water) is often desired in residential, commercial, and industrial environments. For example, chemical additives such as ozone and chlorine have been used as water disinfectants; however, such additives when used alone may be costly or limited in effectiveness. Mercury vapor lamps have also been used to disinfect fluids; however, the installation and maintenance costs of mercury vapor disinfection systems may also be very costly.

An additional issue in conventional systems is that the piping that houses the fluid to be disinfected, or at least some portions of the piping or other carrier, should be periodically cleaned. A problem that exists in periodically cleaning is that it may be unclear at what interval the piping or other surface should be cleaned. As such, cleaning may be performed at excessive intervals, resulting in correspondingly excessive maintenance costs. Alternatively, such cleaning may be conducted only when a problem with the fluid is very evident, resulting in potential system downtime and incident costs (e.g., overtime costs, scheduling costs, material requisitioning costs, etc.).

As such, it would be desirable to provide a fluid treatment and/or disinfection system with improved efficiency, cost-effectiveness, and maintainability.

### SUMMARY OF THE INVENTION

In an exemplary embodiment of the present invention, a system for exposing a fluid to UV energy for treatment of the fluid is provided. The system includes a fluid passageway at least partially defined by a UV energy transmissive barrier. The system also includes at least one UV energy source positioned to transmit UV energy through the UV energy transmissive barrier and into the fluid passageway. Additionally, at least one UV energy sensor is positioned to sense UV energy transmitted through the UV energy transmisive barrier. The sensor is configured to detect a reduced amount of UV energy transmitted through the UV energy transmissive barrier.

In another exemplary embodiment of the present invention, a method of exposing a fluid to UV energy for treatment of the fluid is provided. The method includes transmitting UV energy through a UV energy transmissive barrier and into a fluid passageway, thereby exposing fluid in the fluid passageway to UV energy. The method also includes sensing the amount of UV energy transmitted through the UV energy transmissive barrier.

### BRIEF DESCRIPTION OF THE DRAWINGS

Exemplary embodiments of the invention will be described with reference to the drawings, of which:

FIG. 1 is a perspective view of a portion of a system for exposing a fluid to UV energy in accordance with an exemplary embodiment of the present invention;

FIG. 2 is a side view of a UV energy source array in accordance with an exemplary embodiment of the present invention;

FIG. 3 is a top view of a portion of another system for exposing a fluid to UV energy in accordance with an exemplary embodiment of the present invention;

FIG. 4 is a perspective view of a portion of the system illustrated in FIG. 3;

FIG. 5 is a schematic diagram illustrating operation of yet another system for exposing a fluid to UV energy in accordance with an exemplary embodiment of the present invention; and

FIG. 6 is a flow diagram illustrating a method of exposing a fluid to UV energy for treatment of the fluid in accordance with an exemplary embodiment of the present invention.

### DETAILED DESCRIPTION OF THE INVENTION

Preferred features of selected embodiments of this invention will now be described with reference to the figures. It will be appreciated that the spirit and scope of the invention is not limited to the embodiments selected for illustration. Also, it should be noted that the drawings are not rendered to any particular scale or proportion. It is contemplated that any of the configurations and materials described hereafter can be modified within the scope of this invention.

Referring to the figures generally, a system for exposing a fluid to UV energy for treatment of the fluid is provided. The system includes a fluid passageway 100, 300, 500a, 500b at least partially defined by a UV energy transmissive barrier 101, 302a, 511, 521, respectively. The system also includes at least one UV energy source 106, 400, 512, 522 positioned to transmit UV energy through UV energy transmissive barrier 101, 302a, 511, 521, respectively, and into the fluid passageway 100, 300, 500a, 500b, respectively. Additionally, at least one UV energy sensor 108 is positioned to sense UV energy transmitted through UV energy transmissive barrier 101. The at least one sensor 108 is configured to detect a reduced amount of UV energy transmitted through UV energy transmissive barrier 101, 302a, 511, 521.

In another exemplary embodiment of the present invention, a method of exposing a fluid to UV energy for treatment of the fluid is provided. The method includes a step 602 of transmitting UV energy through a UV energy transmissive barrier 101, 302a, 511, 521, and into a fluid passageway 100, 300, 500a, 500b, thereby exposing fluid in the fluid passageway 100, 300, 500a, 500b to UV energy. The method also includes a step 604 of sensing the amount of UV energy transmitted through the UV energy transmissive barrier 101, 302a, 511, 521.

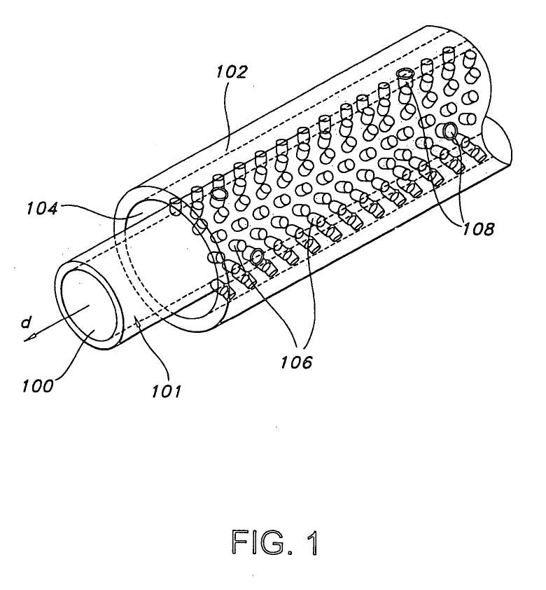

Referring specifically to FIG. 1, UV energy transmissive barrier 101 is provided for at least partially containing a fluid flowing in a direction “d.” Fluid passageway 100 is at least partially defined by UV transmissive barrier 101, where UV transmissive barrier 101 is at least partially constructed of a UV transmissive material (e.g., UV transmissive plexiglass, UV transmissive glass, UV transmissive quartz). Fluid passageway 100 and UV energy transmissive barrier 101 are surrounded by outer enclosure 102.

It may be desirable to at least partially treat and/or disinfect the fluid flowing in fluid passageway 100. As such, a number of UV energy sources 106 (e.g., lights emitting diodes-LEDs) are provided to transmit UV energy through UV transmissive barrier 101 and into fluid passageway 100. This UV energy, for example, may be of a wavelength that substantially limits the ability of bacteria in the fluid to reproduce. According to the exemplary embodiment of the present invention illustrated in FIG. 1, the UV energy sources 106 are provided on or adjacent an interior surface of outer enclosure 102 facing UV energy transmissive barrier 101 that defines fluid passageway 100. As such, UV energy transmitted from UV energy sources 106 is transmitted towards the fluid through UV energy transmissive barrier 101. For example, UV energy sources 106 may be positioned along the entire interior circumference of outer enclosure 102, or a portion thereof, along a predetermined length of outer enclosure 102. This group of UV energy sources is referred to herein as a UV energy array.

According to an exemplary embodiment of the present invention, the portion of fluid passageway 100 defined by UV transmissive barrier 101 may be, for example, a UV transmissive plexiglass pipe.

In an alternative embodiment of the present invention, UV energy sources 106 may be positioned along an exterior surface of outer enclosure 102, so long as outer enclosure 102 is at least partially UV transmissive. Further still, UV energy sources may be provided along an interior surface of UV energy transmissive barrier 101 so long as the UV energy sources are substantially immune to the effects of fluid immersion.

After a certain period of operation, the system for exposing a fluid to UV energy described herein may not be able to treat or disinfect the fluid adequately or the efficiency of such treatment may be reduced. For example, fluid passageway 100 or UV energy transmissive barrier 101 may become contaminated and/or dirty such that an adequate amount of UV energy may not be transmitted to the fluid in fluid passageway 100. Accordingly, it has been discovered that UV energy sensors 108 are advantageously provided to measure the UV energy that is transmitted to and through the fluid in fluid passageway 100. For example, UV energy sensors 108 may be provided among UV energy sources 106 included in the UV energy source array, as illustrated in FIG. 1.

In an exemplary embodiment of the present invention, UV energy sources 106 and UV energy sensors 108 are provided around the entire interior circumference of outer enclosure 102. In such an embodiment, UV energy sensors 108 that are provided on one side of outer enclosure 102 can receive UV energy transmissions from UV energy sources 106 on the opposite side of outer enclosure 102. As such, when UV energy transmissive barrier 101 (or an area of fluid passageway 100) has accumulated scale or buildup along its sidewalls such that adequate UV energy can not be transmitted to treat the fluid efficiently, UV energy sensors can provide an appropriate indication, or commence an appropriate action (e.g., shut off fluid flow to fluid passageway 100).

FIG. 1 also illustrates an annular gap 104 between UV energy transmissive barrier 101 and outer enclosure 102. By operating UV energy sources 106 to treat the fluid in fluid passageway 100, heat is generated which may cause scaling or other buildup on an inside wall of UV energy transmissive barrier 101. Cooling gas (e.g., cool air) may be provided in gap 104 to reduce the heat generated, thereby reducing or substantially eliminating this potential scaling and/or buildup.

Although FIG. 1 illustrates UV energy transmissive barrier 101 and outer enclosure 102 as having a substantially cylindrical shape, they are not limited thereto. For example, UV energy transmissive barrier 101 may be a rounded pipe, an oval shaped pipe, or a barrier having a square or rectangular configuration. Further, outer enclosure 102 may be replaced by arcuate portions for supporting UV energy sources 106, straight supports for supporting UV energy sources 106, or other square or rectangular support structures.

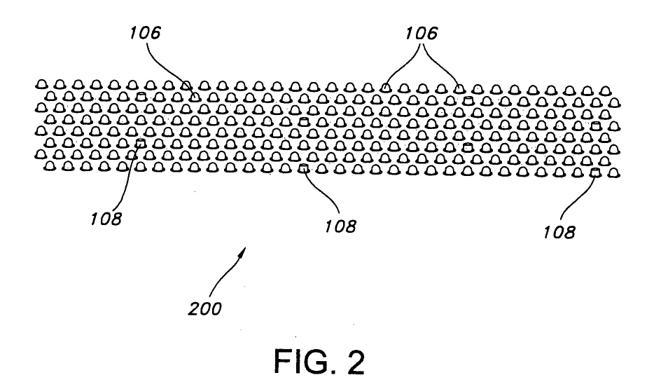

FIG. 2 illustrates UV energy source array 200 for use in a system for exposing a fluid to UV energy (e.g., to treat and/or disinfect the fluid). UV energy source array 200 includes UV energy sources 106 (e.g., LEDs) and UV energy sensors 108. The number of UV energy sources 106 to be included in array 200, and the spacing of the UV energy sources 106, can vary considerably. Further, the number of UV energy sensors 108, the spacing of UV energy sensors 108, and the position of UV energy sensors 108, may also vary considerably.

Factors that affect these UV energy source and UV energy sensor design considerations include, for example, the flow rate of the fluid in a fluid passageway, the volume of fluid to be treated, and the energy required to treat the fluid in particular applications. The energy required will vary based on the fluid flow rate, the fluid volume, the impurities or microorganisms in the fluid, and other factors.

Although illustrated as having a rectangular shape in FIG. 2, UV energy source array 200 may have any of a number of shapes and configurations. For example, the shape of UV energy source array 200 may be similar to the shape of the UV energy transmissive barrier defining the fluid passageway (e.g., a cylindrical pipe-shaped UV energy transmissive barrier defining the fluid passageway may be surrounded by a cylindrical pipe-shaped UV energy source array 200). Alternatively, the shape of UV energy source array 200 may be any of a number of shapes so long as adequate UV energy is transmitted to the fluid in the fluid passageway.

UV energy sensors 108 used in conjunction with the present invention may be configured to constantly monitor the UV energy transmitted through the UV transmissive barrier. Alternatively, UV energy sensors 108 may monitor the UV energy transmitted through the UV transmissive barrier at predetermined intervals.

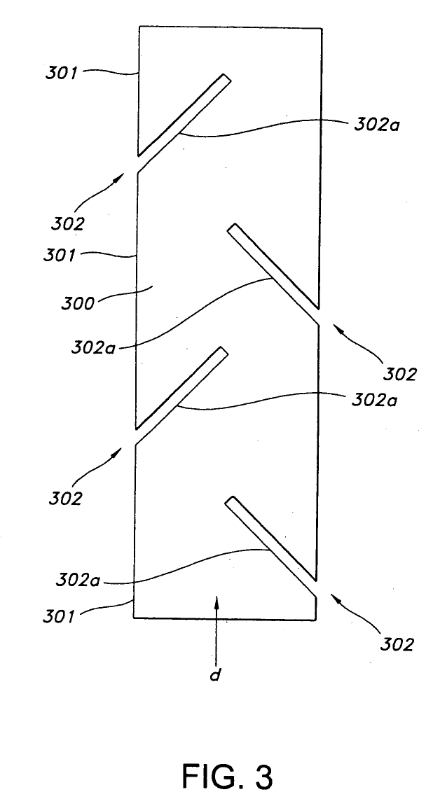

In accordance with another exemplary embodiment of the present invention, FIG. 3 illustrates fluid passageway 300 partially defined by side walls 301. This can optionally provide a wier or flume configuration with a partially or completely open top. Fluid passageway 300 is also partially defined by apertures or slots 302 that are formed in side walls 301, where slots 302 are at least partially defined by walls 302a extending into the passageway 300. Fluid flows through fluid passageway 300 in direction “d.” As fluid travels through fluid passageway 300 and collides with walls 302a, turbulence is generated within the fluid such that the fluid is at least partially mixed.

In the embodiment illustrated in FIG. 3, at least a portion of walls 302a are constructed of a UV energy transmissive material such that UV energy may be transmitted through walls 302a and into the fluid flowing in fluid passageway 300. Although not illustrated in FIG. 3, the passageway 300 can be modified such that the areas behind walls 302a (between walls 302a and side walls 301) may be blocked or otherwise eliminated or reduced to reduce the stagnation of fluid in such areas, as desired.

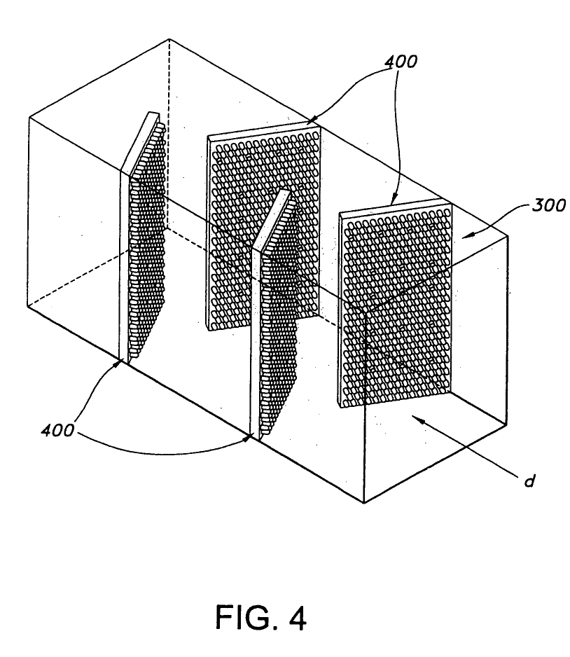

FIG. 4 is a perspective view of fluid passageway 300. In this embodiment, UV energy source arrays 400 are provided in each of apertures 302 (i.e., slots 302). For example, UV energy source array 400 may be similar in design to UV energy source array described by reference to FIG. 2. Because at least a portion of walls 302a (illustrated in FIG. 3) are constructed of a UV energy transmissive material, UV energy may be transmitted from UV energy source arrays 400 to the fluid flowing in fluid passageway 300. Additionally, because walls 302a are disposed at angles with respect to the remainder of fluid passageway 300 (and with respect to the fluid flowing in fluid passageway 300), the turbulence generated within the fluid results in superior UV energy transmission distribution throughout the fluid.

Although UV energy sensors are not specifically illustrated in FIG. 4, it is contemplated that such sensors could be provided in any of a number of positions to sense the UV energy provided by UV energy source arrays 400. For example, UV energy sensors may be positioned on side walls 301 partially defining fluid passageway 300, opposite UV energy source arrays 400. Alternatively, sensors 108 are optionally positioned within or adjacent apertures 302. The sensors 108 can be optionally positioned within or above passageway 300 as well.

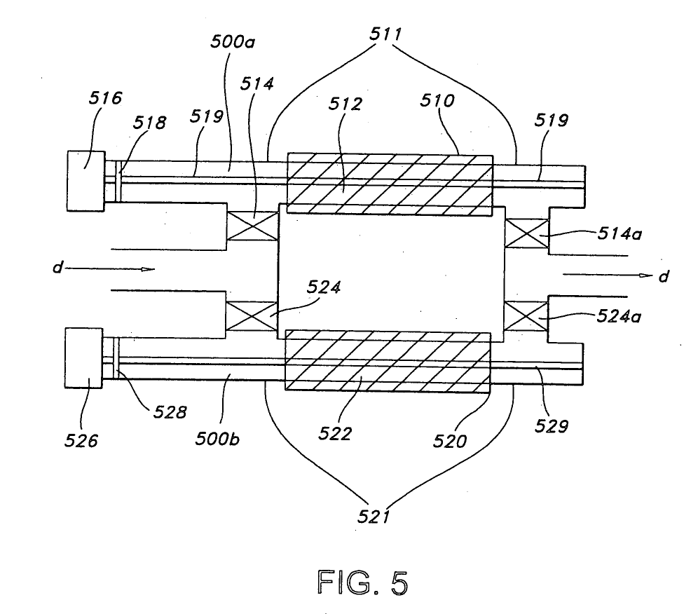

FIG. 5 is a schematic diagram illustrating a system for exposing a fluid to UV energy to treat and/or disinfect the fluid. The system includes a fluid passageway 500a at least partially defined by UV energy transmissive barrier 511, and another fluid passageway 500b at least partially defined by UV energy transmissive barrier 521. UV energy transmissive barrier 511 extends through outer enclosure 510, and UV energy transmissive barrier 521 extends through outer enclosure 520.

Outer enclosure 510 houses UV energy source array 512 (e.g., LED array 512), and outer enclosure 520 houses UV energy source array 522. For example, the configuration of UV energy source arrays 512 and 522, with respect to outer enclosures 510 and 520, may be similar to the configurations described by reference to FIG. 1. UV energy source array 512 (or UV energy source array 522) provides UV energy to a fluid flowing through the fluid passageway defined by UV energy transmissive barrier 511 (or the fluid passageway defined by UV energy transmissive barrier 521).

Although barrier 511 and barrier 521 are described as being UV energy transmissive, it is not necessary that the entire length of barrier 511 and barrier 521 be UV energy transmissive. For example, it may be practical in certain circumstances to only provide the portion of barrier 511 (or barrier 521) that is adjacent UV energy source array 512 (or UV energy sources array 522) as UV energy transmissive.

The system illustrated in FIG. 5 also includes valves 514, 514a, 524, and 524a. Fluid flows in direction “d” from the left to the right, as illustrated in FIG. 5. For example, if valves 514 and 514a are open, and valves 524 and 524a are closed, fluid will flow through the fluid passageway defined by UV energy transmissive barrier 511. Conversely, if valves 524 and 524a are open, and valves 514 and 514a are closed, fluid will flow through the fluid passageway defined by UV energy transmissive barrier 521. Further still, if each of valves 514, 514a, 524, and 524a are open (or at least partially open) fluid will flow through the fluid passageways defined by both UV energy transmissive barrier 511 and UV energy transmissive barrier 521. Further still, each of valves 514, 514a, 524, and 524a may be closed for some period if desired.

In order to treat and/or disinfect the fluid flowing through the fluid passageway defined by UV energy transmissive barrier 511, UV energy is transmitted toward the fluid using UV energy source array 512. Further, in order to treat and/or disinfect the fluid flowing through the fluid passageway defined by UV energy transmissive barrier 521, UV energy is transmitted toward the fluid using UV energy source array 522.

In the scenario where fluid flows through the fluid passageway defined by UV energy transmissive barrier 511 (i.e., valves 514 and 514a are open, valves 524 and 524a are closed), after some period of operation, UV transmissive barrier 511 may become dirty or fouled (e.g., from scaling or other buildup) such that adequate UV energy may not be transmitted through UV transmissive barrier 511 to treat and/or disinfect the fluid adequately or efficiently. In order to determine if adequate UV energy is transmitted to the fluid, UV energy sensors 108 included in the UV energy source array 512 may continuously or periodically sense transmitted UV energy.

If adequate UV energy is not being transmitted to the fluid because UV transmissive barrier 511 should be cleaned, flow of the fluid can be diverted from the fluid passageway defined by UV energy transmissive barrier 511 to the fluid passageway defined by UV energy transmissive barrier 521. Such a diversion can be accomplished, for example, by closing valves 514 and 514a, and opening valves 524 and 524a.

Alternatively, valves 514 and 514a may be partially closed to reduce fluid flow in the fluid passageway defined by UV energy transmissive barrier 511. Because the volume of fluid to be treated is now reduced, adequate UV energy may be provided to treat the fluid in the fluid passageway defined by UV energy transmissive barrier 511.

The system illustrated in FIG. 5 also includes a cleaning system for cleaning either of UV transmissive 511 or 521. The exemplary cleaning system for UV transmissive 511 illustrated in FIG. 5 includes cleaning device shaft 519 and cleaning device head 518. Cleaning device head 518 moves along cleaning device shaft 519 using power and control provided from motor control 516. Similarly, the cleaning system for UV transmissive barrier 521 includes cleaning device shaft 529 and cleaning device head 528. Cleaning device head 528 moves along cleaning device shaft 529 using power and control provided from motor control 526.

As such, in the event that fluid is diverted from the fluid passageway defined by UV energy transmissive barrier 511 to the fluid passageway defined by UV energy transmissive barrier 521, the cleaning system including cleaning head 518 can be used to clean UV transmissive barrier 511. For example, cleaning head 518 can be moved along cleaning device shaft 519 to scrub and clean the sidewalls of UV transmissive barrier 511 (e.g., UV transmissive plexiglass pipe). Likewise, in the event that fluid is diverted from the fluid passageway defined by UV energy transmissive barrier 521 to the fluid passageway defined by UV energy transmissive barrier 511, the cleaning system including cleaning head 528 can be used to clean UV transmissive barrier 521.

The diversion of fluid flow from the fluid passageway defined by UV energy transmissive barrier 511 to the fluid passageway defined by UV energy transmissive barrier 521 (or vice-versa) may be configured to be automatic upon the UV energy sensors determining that adequate UV energy can not be transmitted to the fluid through UV transmissive barrier 511. Alternatively, an indication of the dirty or fouled status of UV transmissive barrier 511 (or UV transmissive barrier 521) may be provided such that the transfer of flow may be accomplished manually.

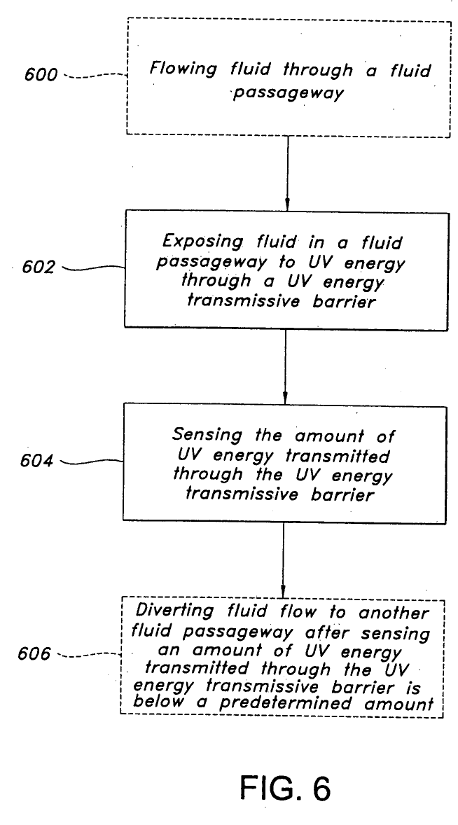

FIG. 6 is a flow diagram illustrating a method of exposing a fluid to UV energy for treatment and/or disinfection of the fluid. At optional step 600 fluid flows through a fluid passageway. Step 600 is optional because the present invention may also be utilized to expose a fluid to UV energy if the fluid is stationary (i.e., not flowing). At step 602, a fluid in a fluid passageway is exposed to UV energy by transmitting UV energy through a UV energy transmissive barrier at least partially defining the fluid passageway. For example, the UV energy transmitted may be provided by a UV energy source array including a plurality of UV energy sources (e.g., LEDs), as illustrated in FIGS. 1-4. At step 604 the amount of UV energy transmitted through the UV energy transmissive barrier is sensed. For example, the UV energy may be sensed by UV energy sensors similar to those described by reference to FIGS. 1-3.

At optional step 606, fluid flow is diverted from the fluid passageway to another fluid passageway after sensing an amount of UV energy transmitted through the UV energy transmissive barrier is below a predetermined amount. For example, this diversion of fluid flow may be accomplished using a system similar to that described by reference to FIG. 5.

By using a system including UV energy sources (e.g., LEDs) to treat and/or disinfect the fluid, various benefits over alternative fluid treatment and disinfection systems (e.g., using Mercury vapor lamps) may be provided, for example: lower energy source cost, lower energy requirements, substantially non-explosive energy source (therefore eliminating or substantially reducing potential exposure of the fluid to mercury), longer energy source life, more consistent energy output over the lifetime of the energy source, and simplified and inexpensive maintenance and replacement of energy sources.

By providing the UV energy sensors to sense UV energy transmitted through the UV transmissive barrier at least partially defining the fluid passageway, an accurate cleaning schedule of a fluid passageway (including the UV transmissive barrier) may be provided. As such, cleaning of the fluid passageway may be scheduled based on actual data from the UV energy sensors, as opposed to having a fixed cleaning schedule. As such, fewer cleaning operations may be conducted.

Although the present invention has primarily been described as exposing a fluid to UV energy when the fluid is flowing, is not limited thereto. The systems and methods of exposing a fluid to UV energy disclosed herein apply to stationary fluids (e.g., in a vessel) as well as fluids that are in motion.

Although the present invention has primarily been described with respect to LEDs being the UV energy sources, it is not limited thereto. Any UV energy source may be utilized so long as the UV energy source can produce enough energy to adequately treat and/or disinfect the fluid.

Although the cleaning system of the present invention has been described primarily as a cleaning device head that moves along a cleaning device shaft, it is not limited thereto. Any cleaning device or system may be utilized that can adequately clean any scale or buildup from the fluid passageway, particularly the UV transmissive barrier at least partially defining the fluid passageway. For example, a chemical may be deposited into the fluid passageway to react with, and remove, scale and/or buildup from the UV transmissive barrier at least partially defining the fluid passageway.

Although the present invention has primarily been described in terms of UV energy sensors positioned adjacent a first side of a fluid passageway for sensing UV energy from UV energy sources positioned adjacent a second side of the fluid passageway (substantially opposite from the UV energy sensors), it is not limited thereto. For example, a mirror or other reflective device may be positioned adjacent a first side of the fluid passageway, and the UV energy sources and UV energy sensors may be positioned adjacent an opposite side of the fluid passageway. As such, the UV energy may be transmitted from the UV energy sources across the fluid in the fluid passageway, to the mirror or reflective device on the opposite side of the fluid passageway, and then back to the UV energy sensors. The reflected energy transmitted back may be sensed by the UV energy sensors, and as such, the status of the fluid passageway including the UV energy transmissive barrier at least partially defining the fluid passageway (e.g., clean, dirty, etc.) may be determined.

Although the invention is illustrated and described herein with reference to specific embodiments, the invention is not intended to be limited to the details shown. Rather, various modifications may be made in the details within the scope and range of equivalents of the claims and without departing from the invention.

1. A system for exposing a fluid to UV energy for treatment of the fluid, said system comprising:
a fluid passageway at least partially defined by a UV energy transmissive barrier;
at least one UV energy source positioned to transmit UV energy through said barrier and into said fluid passageway; and
at least one UV energy sensor positioned to sense UV energy transmitted through said barrier, said sensor being configured to detect a reduced amount of UV energy transmitted through said barrier.

2. The system of claim 1 wherein said fluid passageway is configured to accommodate fluid flow.

3. The system of claim 2 comprising a plurality of fluid passageways each at least partially defined by a UV energy transmissive barrier, said system being configured to at least partially divert fluid flow from one of said fluid passageways to another of said fluid passageways after said sensor detects an amount of UV energy transmitted through said barrier of said one fluid passageway is below a predetermined amount.

4. The system of claim 1 wherein said system is configured to reduce fluid flow in the fluid passageway after said sensor detects that an amount of UV energy transmitted through said barrier is below a predetermined amount.

5. The system of claim 1 wherein said at least one UV energy source comprises an LED.

6. The system of claim 1 wherein said at least one UV energy source is positioned adjacent said barrier.

7. The system of claim 1 comprising a plurality of UV energy sources and a plurality of UV energy sensors, each of said plurality of UV energy sensors being positioned to sense UV energy transmitted through said barrier by at least one of said UV energy sources.

8. The system of claim 7 wherein said UV energy sources are positioned adjacent an external surface of said fluid passageway to transmit UV energy through said barrier.

9. The system of claim 7 wherein said UV energy sensors are positioned adjacent an external surface of said fluid passageway for sensing UV energy transmitted through said barrier.

10. The system of claim 1 wherein said UV energy transmissive barrier at least partially defines at least one aperture extending into said fluid passageway, said at least one UV energy source being disposed at feast partially within said aperture to transmit UV energy into said fluid passageway through said UV energy transmissive barrier.

11. The system of claim 1 wherein said UV energy transmissive barrier at least partially defines a plurality of apertures extending into said fluid passageway, said system including a plurality of UV energy sources, and at least one of said UV energy sources being disposed at least partially within each of said apertures to transmit UV energy into said fluid passageway through said UV energy transmissive barrier.

12. The system of claim 11 wherein said plurality of apertures are configured at an angle with respect to a direction of flow of the fluid in said fluid passageway.

13. A method of exposing a fluid to UV energy for treatment of the fluid, said method comprising the steps of:
transmitting UV energy through a UV energy transmissive barrier and into a fluid passageway, thereby exposing fluid in the fluid passageway to UV energy; and
sensing the amount of UV energy transmitted through the UV energy transmissive barrier.

14. The method of claim 13 further comprising the step of:
flowing fluid through the fluid passageway.

15. The method of claim 14 further comprising the step of:
at least partially diverting fluid flow from the fluid passageway to another fluid passageway after sensing an amount of UV energy transmitted through the UV energy transmissive barrier is below a predetermined amount.

16. The method of claim 14 further comprising the step of:
reducing fluid flow in the fluid passageway after sensing that an amount of UV energy transmitted through the UV energy transmissive barrier is below a predetermined amount.

17. The method of claim 13 wherein said transmitting step includes transmitting UV energy from at least one LED through the UV energy transmissive barrier.

18. The method of claim 13 further comprising the step of:
cleaning the UV energy transmissive barrier after the sensed amount of UV energy transmitted through the UV energy transmissive barrier is below the predetermined amount.

19. The method of claim 18 further comprising the step of:
diverting fluid flow from the fluid passageway to another fluid passageway after sensing the amount of UV energy transmitted through the UV energy transmissive barrier is below the predetermined amount.

20. The method of claim 19 further comprising the step of:
at least partially restoring fluid flow from the another fluid passageway to the fluid passageway after the cleaning step.
